(19) United States
(12) Patent Application Publication
(10) Pub. No.: US 2008/0263178 A1
(43) Pub. Date: Oct. 23, 2008

(54) Cell phone remote access to personal computer applications

(75) Inventor: Robert Hogue, Rockland (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/785,475

(22) Filed: Apr. 18, 2007

(51) Int. Cl. G06F 15/16

(52) U.S. Cl. 709/218

(57) ABSTRACT

A compact, handheld, portable communication device, and associated method, the device including a display that reproduces a display of an application installed on a personal computer, a means of remotely communicating with the personal computer through a communication network, and a means of executing a command for the application installed on the personal computer by entering the command on the display of the compact, handheld, portable communication device and transmitting the command to the personal computer through the communication network, wherein the compact, handheld portable communication device is of a size and weight that it fits in the pocket of a garment worn by a user of the compact, handheld, portable communication device.

### BACKGROUND OF THE INVENTION

1. Field of the Invention

This invention relates generally to remote access to applications installed on a personal computer made by a compact handheld portable communication device.

2. Description of Related Art

Compact, handheld, portable cellular telephones are known. Likewise, other compact, handheld, portable communication devices such as Blackberry's are known. It is believed that still other forms of compact, handheld, portable communication devices will be known in the future.

Similarly, personal computers are known. Many applications exist on personal computers. However, there is no known device, system or method for remote access to an application installed on a personal computer made by a compact, handheld, portable communication device. Thus, there is a need for a compact, handheld, portable communication device capable of remotely accessing applications installed on a personal computer. Likewise, there is a need for a method of remotely accessing applications installed on a personal computer from a compact, handheld, portable communication device.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for remote access to applications installed on a personal computer made by a compact handheld portable communication device, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various embodiments include compact, handheld, portable communication device with a a display that reproduces a display of an application installed on a personal computer, a means of remotely communicating with the personal computer through a communication network, and a means of executing a command for the application installed on the personal computer by entering the command on the display of the compact, handheld, portable communication device and transmitting the command to the personal computer through the communication network, wherein the compact, handheld portable communication device is of a size and weight that it fits in the pocket of a garment worn by a user of the compact, handheld, portable communication device.

In some embodiments the compact, handheld, portable communication device is a cellular telephone. In other embodiments, the compact, handheld, portable communication device is a Blackberry. In still other embodiments, the compact, handheld, portable communication device is some other type of device. In some embodiments, the communication network is a cellular telephone communication network. In some embodiments, the application installed on the personal computer is a file transfer application.

Various embodiments include a method of remotely accessing an application installed on a personal computer, the method including steps such as accessing a communication network with a compact, handheld, portable communications device that is of such a size and weight that it fits in a pocket of a garment worn by a user of the compact, handheld, portable communications device, reaching a personal computer through the communications network, opening the application installed on the personal computer, transmitting a display of the application installed on the personal computer to the compact, handheld, portable communications device through the communications network, reproducing the display of the application installed on the personal computer in a display of the compact, handheld, portable communications device, remotely entering a command for the application installed on the personal computer, the command being remotely entered on the display of the compact, handheld, portable communications device, transmitting the command for the application installed on the personal computer from the compact, handheld, portable communications device to the personal computer by way of the communications network, and executing the command for application installed on the personal computer.

In some embodiments, reaching a personal computer through the communications network further includes communicating with the personal computer through a local area network. Some embodiments include entering authentication information in order for the personal computer to be reached through the communications network. In some embodiments, reaching a personal computer through the communications network further includes communicating with the personal computer through an Internet protocol address.

### BRIEF DESCRIPTION OF THE DRAWINGS

In order to better understand various exemplary embodiments, reference is made to the accompanying drawings, wherein:

FIG. 1 shows a schematic diagram of an exemplary system for accessing applications installed on a personal computer from a compact, handheld, portable communication device; and

FIG. 2 shows a flowchart of an exemplary method for accessing an application installed on a personal computer from a compact, handheld, portable communication device.

### DETAILED DESCRIPTION OF THE PREFERRED EMBODIMENTS OF THE INVENTION

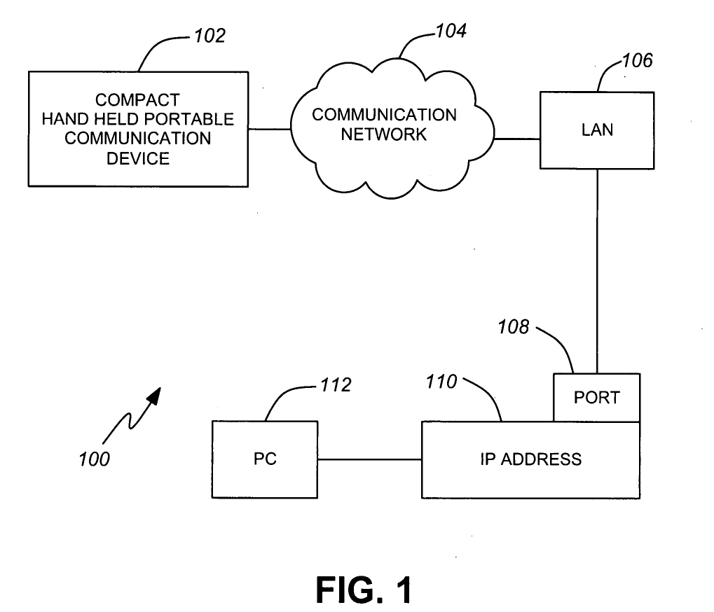

Referring now to the drawings, in which like numerals refer to like components or steps, there are disclosed broad aspects of various exemplary embodiments. FIG. 1 is a schematic diagram showing an exemplary system 100 for accessing an application installed on a personal computer (PC) 112 from a compact, handheld, portable communication device 102.

In the exemplary system 100, the compact, handheld, portable communication device 102 engages in communications via communication network 104. In some embodiments, the compact, handheld, portable communication device 102 is a cellular telephone. In other embodiments, the compact, handheld, portable communication device 102 is a Blackberry. In still other embodiments, the compact, handheld, portable communication device 102 is some other such device.

However, it should be noted that laptop computers are cumbersome and difficult to transport relative to, for example, a cellular telephone or a Blackberry. Laptop computers are too large and too heavy to be carried in a pocket. The compact, handheld, portable communication device 102 is small enough and light enough that it can be carried in the pocket of a garment such as a suit pocket.

In the exemplary system 100, the compact, handheld, portable communication device 102 accesses a local area network (LAN) 106 by way of the communication network 104. Then, the compact, handheld, portable communication device 102 communicates with a port 108 connected to an Internet protocol (IP) address 110 for the PC 112.

In other embodiments, the LAN 106 is omitted. Thus, in some embodiments, the compact, handheld, portable communication device 102 communicates with a PC 112 that is located in an individual residence or other location that does not utilize or require a LAN 106.

In some embodiments, the means to remotely access PC 112 includes encrypted software. Thus, in some embodiments, the user of the compact, handheld, portable communication device 102 must properly enter an authentication password in order to gain access to the PC 112 remotely.

In some embodiments, the communication network 104 is a cellular telephone network. It should be apparent that, the compact, handheld, portable communication device 102 may be a cellular telephone in embodiments where the communication network 104 is a cellular telephone communication network.

In other embodiments, the communication network 104 is a satellite communication network. In still other embodiments, the communication network 104 is another form of a communication network currently known, or later developed.

According to the foregoing, the system 100 is utilized in situations where a user of the compact, handheld, portable communication device 102 desires to access an application installed on the PC 112. For example, the user of the compact, handheld, portable communication device 102 may be a business person traveling for business. The traveling business person takes a call from a colleague, a customer, or a client, and the traveling business person needs to perform a function associated with the application installed on the PC 112 for a caller. In the past, there would be an undesirable delay before the user of the compact, handheld, portable communication device 102 could access the application installed on the PC 112.

For example, if the user of the compact, handheld, portable communication device 102 is walking when the call is received, that user would need to stop walking, set up a laptop computer, assuming one was available, boot up the laptop computer, and then remotely access the PC 112 from the laptop computer.

In some instances, the user of the compact, handheld, portable communication device 102 would not even be carrying a laptop computer at the time the call was received. Likewise, in other instances, the user of the compact, handheld, portable communication device 102 may actually be seated and working on a laptop computer when the call was received, but in a location where remote access of the PC 112 is not available from the laptop computer.

It is well-known, that communication networks such as cellular telephone communication networks are far more readily available to compact, handheld, portable communication devices 102 than communication networks are available to a laptop computer such as those that operate through wireless communication network cards. Thus, an exemplary method of remotely accessing an application installed on the PC 112 from the compact, handheld, portable communication device 102 includes the following.

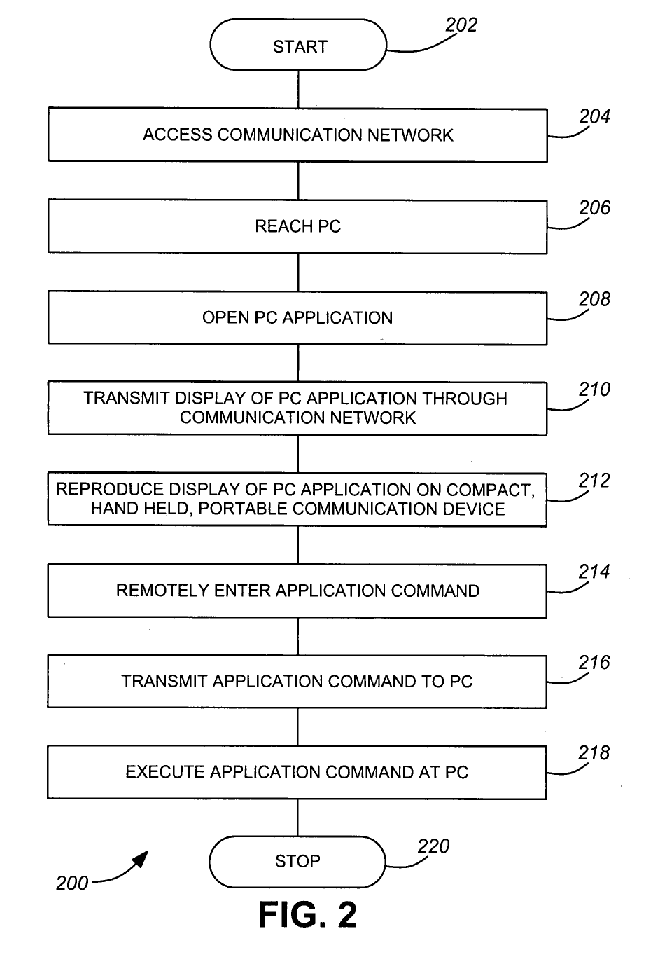

FIG. 2 is a flowchart of an exemplary method 200 of accessing an application installed on a PC 112 from a compact, handheld, portable communication device 102. Exemplary method 200 starts at step 202 and then proceeds to step 204. In step 204, the compact, handheld, portable communication device 102 accesses the communication network 104. Exemplary method 200 then proceeds to step 206.

In step 206 a communication from the compact, handheld, portable communication device 102 reaches the PC 112. Thus, in one embodiment, the communication from the compact, handheld, portable communication device 102 passes from the communication network 104 to the LAN 106, then to the port 108, the IP address 110, and hence to the PC 112. It should be apparent that in step 206, the communication reaches the PC 112 from the communication network 104 by way of any of the embodiments of the system 100 described above in connection with FIG. 1.

After reaching the PC 112 in step 206, the method 200 proceeds to step 208 where the application installed on the PC 112 is opened (or accessed if it is already opened). The method 200 then proceeds to step 210.

In step 210, the display of the application installed on the PC 112 that would appear, or does already appear, on the display of the PC 112 is transmitted through the communication network 104 to the compact, handheld, portable communication device 102. In one embodiment, according to the system 100, the display of the application on the PC 112 is transmitted from the PC 112 to the IP address 110 through port 108 to LAN 106 and then through the communication network 104 to the compact, handheld, portable communication device 102. Again, it should be apparent that in other embodiments of the method 200, the display of the application from the PC 112 is transmitted through the communication network 104 to the compact, handheld, portable communication device 102 according to any of the embodiments of system 100 described above in connection with FIG. 1.

Once the display of the application from the PC 112 is received by the compact, handheld, portable communication device 102, that display is reproduced on the compact, handheld, portable communication device 102 in step 212 of method 200. In this manner a display of the compact, handheld, portable communication device 102 has the same appearance as the display of the PC 112 with respect to the application installed on the PC 112.

According to the foregoing, the user of the compact, handheld, portable communication device 102, is able to remotely log on to the PC 112 and reflect the application running on the PC 112 in a display included with the compact, handheld, portable communication device 102. In this manner, the display of the compact, handheld, portable communication device functions as a window to the display of the PC 112.

The display of the compact, handheld, portable communication device 102 reads display traffic from the PC 112 in some embodiments. Thus, in some embodiments, the compact, handheld, portable communication device 102 makes conversions and/or compressions as appropriate to display the information from the application running on the PC 112 in a corresponding manner on the display of the compact, handheld, portable communication device 102.

According to the foregoing, it is believed that any currently known, or later developed, operating system for the PC 112 would be capable of functioning in the system 100 and method 200 so long as that operating system has the capability of remote access.

In order to aid in minimizing the size that can be achieved for the compact, handheld, portable communication device 102, it is believed to be desirable that the software loaded on the compact, handheld, portable communication device 102 to implement the functionality of the method 200 be as lightweight as possible. Similarly, some embodiments of the compact, handheld, portable communication device 102 would be capable of operating according to the method 200 with different versions of PC 112 running different operating systems.

It should also be apparent that, in some embodiments, data is transferred from the PC 112 to the compact, handheld, portable communication device 102. In some instances, data transmitted from the PC 112 to the compact, handheld, portable communication device 102 is data in the form of an electronic file. In some instances, the data is of some form other than an electronic file.

It should also be apparent that, in some embodiments, the data received by the compact, handheld, portable communication device 102 from the PC 112 is subsequently forwarded to a third device. For example, it should be apparent that, in some embodiments, the user of the compact, handheld, portable communication device 102 receives a request from a third party for the data, retrieves the data from the PC 112, and subsequently forwards the data to an electronic device of the third party making the request for the data. In some embodiments, the data is manipulated by the compact, handheld, portable communications device 112. Thus, in some embodiments the data is forwarded back to the PC 112 in an altered form.

Once the display of the application from the PC 112 is reproduced on the display of the compact, handheld, portable communication device 102, a command for the application installed on the PC 112 is entered remotely at the compact, handheld, portable communication device 102 in step 214 of method 200. The method 200 then proceeds to step 216 where the application command remotely entered in step 214 is transmitted to the PC 112. Again, it should be apparent that the components through which the command transmitted in step 216 pass between the compact, handheld, portable communication device 102 and the PC 112 are according to any of the embodiments of system 100 described above in connection with FIG. 1.

Once the application command for the PC 112 remotely entered at the compact, handheld, portable communication device 102 is received at the PC 112, that application command is executed at the PC 112 in step 218 of method 200.

Examples of commands executed at PC 112 in step 218 include file transfer commands. This would be beneficial, for example, where the caller to the user of the compact, handheld, portable communication device 102 needs a file stored on PC 112, and that file is not otherwise available to the remote user of the compact, handheld, portable communication device 102.

It should be apparent that in steps 208, 210 and other steps of method 200, the compact, handheld, portable communication device 102 does not access the entire environment of the desktop of the PC 112 in all embodiments. Rather, in some embodiments, the compact, handheld, portable communication device 102 only accesses a portion of the environment available on the desktop display of the PC 112 necessary to open the application installed on the PC 112 in step 208 and display the application installed on the PC 112 in step 210.

It should also be apparent that the compact, handheld, portable communication device 102 includes a sufficient amount of memory to implement the system 100 and method 200 according to the functionality and other description above. Following step 218, the method 200 proceeds to step 220 where the method 200 stops.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A compact, handheld, portable communication device, comprising:
a display that reproduces a display of an application installed on a personal computer;
a means of remotely communicating with the personal computer through a communication network; and
a means of executing a command for the application installed on the personal computer by entering the command on the display of the compact, handheld, portable communication device and transmitting the command to the personal computer through the communication network,
wherein the compact, handheld portable communication device is of a size and weight that it fits in the pocket of a garment worn by a user of the compact, handheld, portable communication device.

2. The compact, handheld, portable communication device according to claim 1, wherein the device is a cellular telephone.

3. The compact, handheld, portable communication device according to claim 1, wherein the device is a Blackberry.

4. The compact, handheld, portable communication device according to claim 1, wherein the device communicates with the personal computer through a communication network by way of a local area network.

5. The compact, handheld, portable communication device according to claim 1, wherein the user must enter authentication information in order for the device to communicate with the personal computer.

6. The compact, handheld, portable communication device according to claim 1, wherein the device communicates with the personal computer through a communication network by way of an Internet protocol address.

7. The compact, handheld, portable communication device according to claim 1, wherein the communication network is a cellular telephone communication network.

8. The compact, handheld, portable communication device according to claim 1, wherein the application installed on the personal computer is a file transfer application.

9. The compact, handheld, portable communication device according to claim 1, further comprising a means of receiving data from the personal computer.

10. The compact, handheld, portable communication device according to claim 9, wherein the data is an electronic file.

11. The compact, handheld, portable communication device according to claim 9, further comprising a means of forwarding the data.

12. A method of remotely accessing an application installed on a personal computer, comprising:
accessing a communication network with a compact, handheld, portable communications device that is of such a size and weight that it fits in a pocket of a garment worn by a user of the compact, handheld, portable communications device;
reaching a personal computer through the communications network;
opening the application installed on the personal computer;
transmitting a display of the application installed on the personal computer to the compact, handheld, portable communications device through the communications network;
reproducing the display of the application installed on the personal computer in a display of the compact, handheld, portable communications device;
remotely entering a command for the application installed on the personal computer, the command being remotely entered on the display of the compact, handheld, portable communications device;
transmitting the command for the application installed on the personal computer from the compact, handheld, portable communications device to the personal computer by way of the communications network; and
executing the command for application installed on the personal computer.

13. The method of remotely accessing an application installed on a personal computer according to claim 12, wherein the compact, handheld, portable communication device is a cellular telephone.

14. The method of remotely accessing an application installed on a personal computer according to claim 12, wherein the compact, handheld, portable communication device is a Blackberry.

15. The method of remotely accessing an application installed on a personal computer according to claim 12, wherein reaching a personal computer through the communications network further includes communicating with the personal computer through a local area network.

16. The method of remotely accessing an application installed on a personal computer according to claim 12, further comprising entering authentication information in order for the personal computer to be reached through the communications network.

17. The method of remotely accessing an application installed on a personal computer according to claim 12, wherein reaching a personal computer through the communications network further includes communicating with the personal computer through an Internet protocol address.

18. The method of remotely accessing an application installed on a personal computer according to claim 12, wherein the communication network is a cellular telephone communication network.

19. The method of remotely accessing an application installed on a personal computer according to claim 12, wherein the application installed on the personal computer is a file transfer application.

20. The method of remotely accessing an application installed on a personal computer according to claim 12, further comprising forwarding data from the personal computer to the compact, handheld, portable communication device.

21. The method of remotely accessing an application installed on a personal computer according to claim 20, wherein the data is an electronic file.

22. The method of remotely accessing an application installed on a personal computer according to claim 20, further comprising forwarding the data.
